(19) United States
(12) Patent Application Publication
(10) Pub. No.: US 2008/0288490 A1
(43) Pub. Date: Nov. 20, 2008

(54) System and Methods for Keyword Searches in Unallocated Spaces

(76) Inventors: Steven Bress, Germantown, MD (US); Mark Joseph Menz, Folsom, CA (US); Daniel Bress, Germantown, MD (US)

Correspondence Address: Steve Bress, 7851-C Beechcraft Avenue, Gaithersburg, MD, 20874, US

(21) Appl. No.: 12/121,793

(22) Filed: May 16, 2008

Related U.S. Application Data
(60) Provisional application No. 60/938,456, filed on May 17, 2007.

(51) Int. Cl. G06F 7/02

(52) U.S. Cl. 707/6

(57) ABSTRACT

There are many situations where it is desirable for law enforcement or security officials, and others, to perform a Keyword search on a confiscated memory device. Keyword searches on undeleted files are well known in the art. Often files are deleted in an effort to hinder prosecution. When a file is deleted, the information that connects one chunk of memory to another is often lost. The file is now considered to be in “unallocated space” as the operating system is not tracking the chunks that made up the file anymore. When the information that connects one chunk of memory to another is lost there is no way to perform a keyword search across multiple chunks of memory in the art. The current invention rectifies this situation by providing ways to perform keyword searches across unallocated chunks. Additional the current invention provides methods to reconstruct files that have been deleted.

### BACKGROUND OF THE INVENTION

A. Field of the Invention

The present invention related to computer memory devices and, more specifically, to mechanisms for performing Keyword searches in unallocated space.

A. Description of Related Art

There are many situations where it is desirable for law enforcement or security officials, and others, to perform a Keyword search on a confiscated memory device. Keyword searches on undeleted files are well known in the art. Often files are deleted in an effort to hinder prosecution. When a file is deleted, the information that connects one chunk of memory to another is often lost. The file is now considered to be in “unallocated space” as the operating system is not tracking the chunks that made up the file anymore. When the information that connects one chunk of memory to another is lost there is no way to perform a keyword search across multiple chunks of memory in the art.

Accordingly, there is a need in the art for improved systems and methods to perform keyword searches across multiple chunks of unallocated memory.

### SUMMARY OF THE INVENTION

A keyword fragment at the end of a memory chunk is mated to a keyword fragment at the beginning of another chunk, and a comparison to the keyword is made.

Keyword fragments at the beginning and end of a plurality of chunks are indexed into a database for the purpose of faster retrieval.

Fragments at the beginning and end of a plurality of chunks are analyzed by other algorithms, such as word spelling, grammar checking, etc. in an effort to determine chunk order on the original file.

Frequently used words in a chunk are identified and used as keyword as above.

### BRIEF DESCRIPTION OF THE DRAWINGS

FIG. 1 is an illustration of sectors (chunks) at the beginning of a hard drive.

FIG. 2 is an illustration of a file with contiguous sectors (chunks).

FIG. 3 is an illustration of a file with fragmented sectors (chunks).

FIG. 4 is examples of text in a file straddling two chunks.

FIG. 5 is an example of three text sectors (chunks).

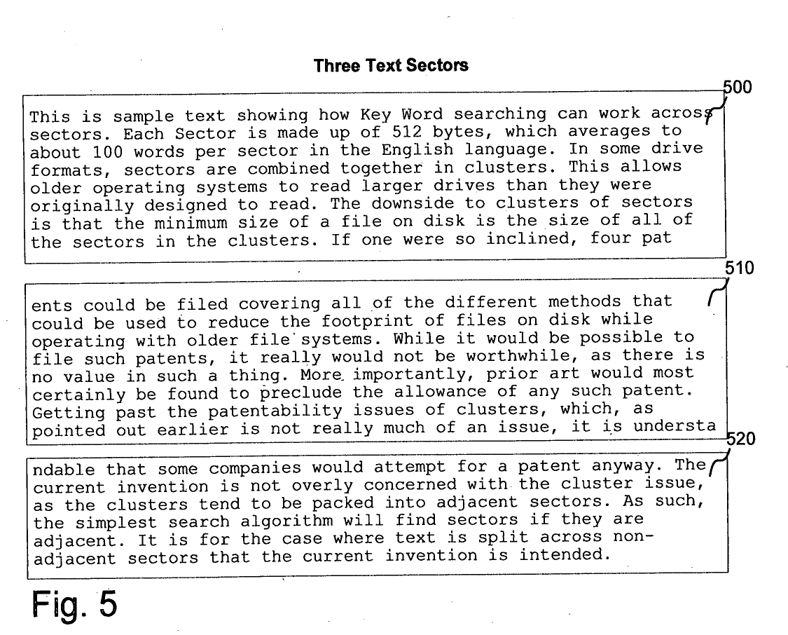

### SUMMARY OF THE INVENTION

When a file is stored on computer memory it is stored as a sequence of sectors. Each sector is typically 512 bytes long. Different storage media may have different size sectors. New hard drives may have 4096 byte sectors. Digital memory devices such as Compact Flash, are essentially big chunks of memory. While they don't have the concept of a sector built in, storage units of 512 bytes are usually defined as one sector in order to make it easier to interpret the memory as a drive.

In order to simplify the discussion (but not limit the invention), the long-term storage device to be discussed will be a hard drive with data stored in a FAT32 format. This description covers a typical drive. One skilled in the art would understand how to apply systems and methods taught about a FAT32 format hard drive to other storage devices and file formats. Additionally, for ease of discussion the word chunk or sector are used interchangeably. They are both used to refer to a predetermined area of a long-term memory storage device.

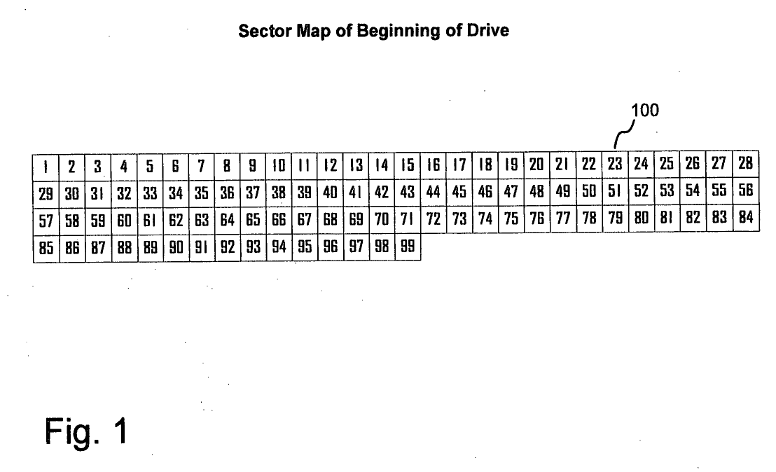

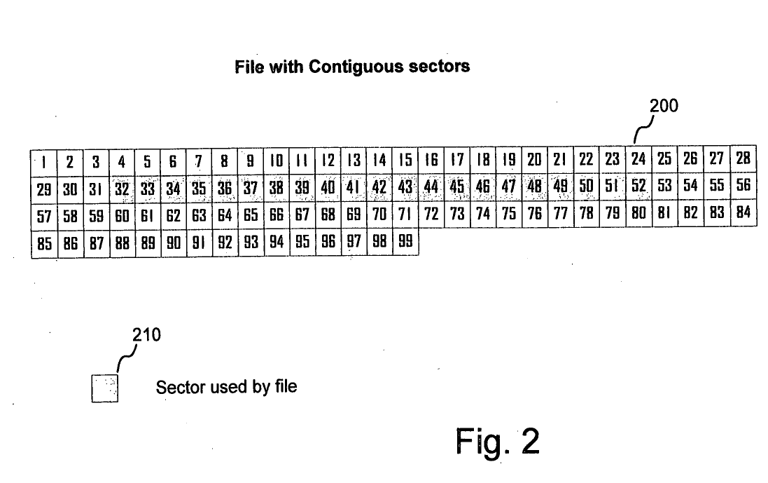

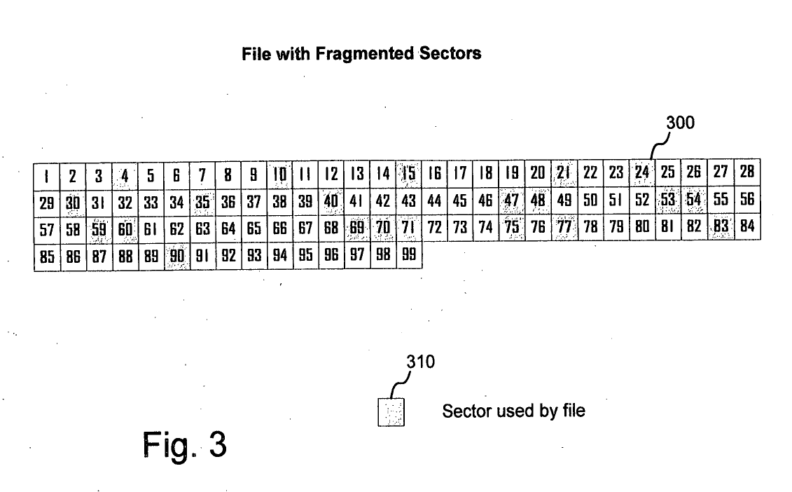

A File Allocation Table (FAT), tracks the relationship of the sectors FIG. 1 shows the beginning of a drive divided into sectors. On a newly formatted disk, a file may be stored as a sequence of consecutive sectors. The highlighted sectors in FIG. 2 illustrate a file stored in contiguous sectors. A drive that has been in use for any amount of time is unlikely to have consecutive sectors to store a file. In this case a file is stored in uncontiguous sectors. The highlighted sectors in FIG. 3 represent a file stored in uncontiguous or fragmented sectors.

The problem occurs when a fragmented file is deleted. In this case the portion of the FAT that stored the list of sectors for the file is unavailable. These sectors, that still contain the file data are now listed by the FAT as unallocated. As far as the operating system is concerned, these sectors are unrelated and ready for reuse.

With the FAT entry gone, there is no easy way available in the art to rebuild the list of sectors that had made up the file. Some forensics programs can perform keyword searches on unallocated sectors, but they will only find words or phrases that are entirely contained within a sector or stored in consecutive sectors. If a keyword is split between non-consecutive sectors, industry standard computer forensic packages, such as Encase from Guidance Software, will not find it.

For computer forensics on a hard drive, software is typically used that can perform keyword searches. When one of the words in the search is found, the file is reported for further analysis. For example, a keyword could be “patent”. Every time the word “patent” appears in a file on the drive under examination, the file would be flagged for review.

Continuing with the “patent” example, if the last 3 bytes of sector 1000 are “pat”, and the first 4 bytes of sector 1001 are “ent”, there is a chance that an existing forensic tool could find it. However, if the file was fragmented, which is the most common state of a file, the “end” could find itself in sector 2500. Without the FAT entry to connect these unrelated sectors there is currently no method in the art to associate these two sectors with each other. This presents a problem as it is possible for evidence to be missed, whether incriminating or exculpatory, in a computer forensics investigation.

### Keyword Search on Unallocated Sectors

A list of keywords is provided. A search is performed at the end of an unallocated sector. If a portion of a keyword is found, the beginning of a plurality of unallocated sectors is searched. If a match is found, the sector pair is reported for further analysis. This method is relatively simple, although computationally intensive. One skilled in the art would understand that the beginning of unallocated sectors could be searched first with identical results.

A refinement of the above search is to create an indexed database with the word fragments on the beginning and ending of a plurality of unallocated sectors. Once this database is created, examining fragments across sectors for keyword matches is performed. This method takes time to set up the database before a keyword search can be conducted. But once the database is setup keyword searches are substantially faster.

### Grammar Search

Sectors found by the above methods may be further validated for accuracy by submitting text found in the sector pairs to a grammar engine for additional analysis. This enhances the initial search by providing a relevance rating to the specified sector pairs. If, when taken together, the two sectors provide multiple sentences that make sense together, the odds are higher that the sector pair actually belongs together. One skilled in the art would appreciate that this method could be used to reconstruct files in unallocated memory without keywords.

### Dictionary Search

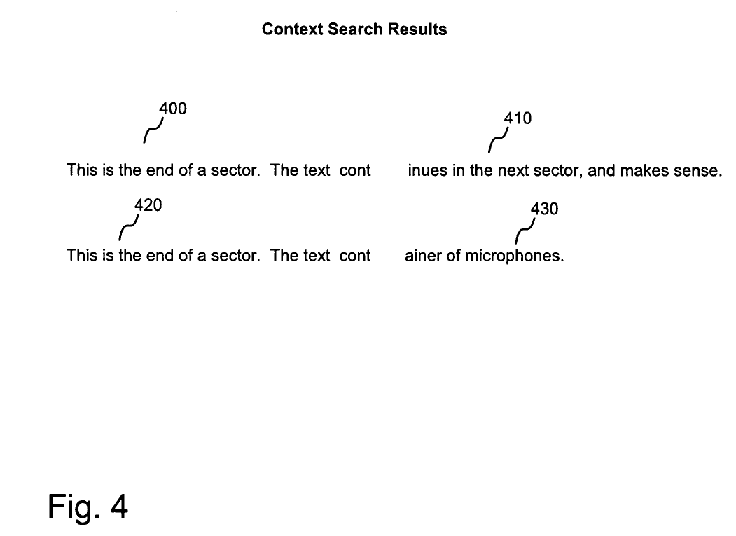

To reconstruct the original file that contained one or more of the keywords a Dictionary Search can be attempted. In this case, a sector that contains a keyword word is subjected to further analysis. Any fragment at the beginning or end of the sector is analyzed for dictionary matches in a plurality of unallocated sectors. FIG. 4 shows the end of a sector 400 and 420 and the matches found by a Dictionary Search in another sector 410 and 430.

In the above example the letters “cont” would be fed into a dictionary program, and a plurality of words that start with the fragment would be generated. This in effect, creates a new keyword list and the unallocated space is then searched with this new list as described above. A refinement of this search method would be to examine consecutive sectors first for a match, to save processor time.

Once a Dictionary Search is successful the result may be further analyzed by a Grammar Search as described above. FIG. 4 should two matches found from a Dictionary Search. Fragments 400 and 410 would pass a Grammar Search, while 420 and 430 would fail a Grammar Search.

### Search Modified by Usage

The searches described above may be modified after an analysis of text found in a plurality of sectors, allocated or unallocated. For example, text files may be checked for consistent incorrect spellings and these incorrectly spelled words used for analysis and searches. In a similar fashion analysis of the grammar used may indicate patterns that can be used in the searches described above.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. Systems and methods for a keyword search between unallocated chunks of a long term memory device, comprising:
Providing a list of keywords; and
Searching the end of an unallocated chunk for a partial match (End Match) to a keyword; and
If an End Match is found then the beginnings of a plurality of unallocated chunks is searched; and
If a match is found (Beginning Match), the sector pair is reported for further analysis.

2. The systems and methods of claim 1, wherein a search for a Beginning Match is performed before a search for an End Match.

3. The systems and methods of claim 1, wherein beginning and ending word fragments of unallocated chunks are indexed into a database before further analysis.

4. The systems and methods of claim 1, wherein the text in paired chunks (a chunk with a Beginning Match and a chunk with an End Match) is further analyzed by other algorithms, such as a Grammar analysis.

5. The Systems and methods of claim 1, wherein additional keywords are generated from a Dictionary Search from fragments at the beginning or end of an unallocated chunk.
